(19) United States
(12) Patent Application Publication
(10) Pub. No.: US 2024/0008395 A1
(43) Pub. Date: Jan. 11, 2024

(54) SPREADER

(71) Applicant: Milwaukee Electric Tool Corporation, Brookfield, WI (US)

(72) Inventors: Jonathon A. Ciepluch, Milwaukee, WI (US); Matthew D. McGrath, Waukesha, WI (US); Eric Boticki, Brookfield, WI (US); Richard A. Behnke, Milwaukee, WI (US); Sean E. Conaway, Milwaukee, WI (US); Nicole Jackson, Brookfield, WI (US); Rade Latinovich, Brookfield, WI (US); Casey Alan Ketterhagen, Hartland, WI (US); Max Crabb, Brookfield, WI (US); Richard P. Brault, Cedarburg, WI (US)

(21) Appl. No.: 18/347,355

(22) Filed: Jul. 5, 2023

Related U.S. Application Data
(60) Provisional application No. 63/359,391, filed on Jul. 8, 2022.
(60) Provisional application No. 63/433,358, filed on Dec. 16, 2022.

(51) Int. Cl. A01C 15/02; A01C 19/02

(52) U.S. Cl. CPC A01C 15/02; A01C 19/02

(57) ABSTRACT

Spreaders are provided for distributing material. A spreader includes a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame; a plurality of wheels operatively connected to the frame for traversing the spreader; and a drive assembly comprising a motor operable to drive one or more of the plurality of wheels, wherein the plurality of wheels can be manually rotated without being driven by the motor, and wherein rotation of the wheels causes the distribution element to rotate.

### CROSS-REFERENCE TO RELATED APPLICATIONS

The present application claims priority to U.S. Provisional Patent Application Ser. No. 63/359,391 filed on Jul. 8, 2022 and U.S. Provisional Patent Application Ser. No. 63/433,358 filed on Dec. 16, 2022, the disclosures of both of which are incorporated by reference herein in their entireties.

### FIELD

The present disclosure relates generally to spreaders, and more particularly, walk-behind spreaders.

### BACKGROUND

Traditionally, spreading materials like seed and fertilizer was performed by hand. The material was positioned about a work area by manual broadcasting. Over time, it has become common to replace the human operator with a machine which can broadcast the material. Machine spreaders can more efficiently spread materials over a work area in a shorter duration of time while providing better distribution of the material. However, these machines are simplistic and rudimentary.

Accordingly, improved spreaders would be desired in the art. In particular, spreaders which improve ease of operation would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a spreader is provided for distributing a material. The spreader includes a hopper assembly defining a receiving area configured to hold the material, the hopper assembly comprising one or more dispersion outlets for releasing the material from the receiving area a distribution element disposed below the one or more dispersion outlets; a frame supporting the hopper assembly; a handle assembly connected to the frame; a plurality of wheels operatively connected to the frame for traversing the spreader; and a drive assembly comprising a motor operable to drive one or more of the plurality of wheels, wherein the plurality of wheels can be manually rotated without being driven by the motor, and wherein rotation of the wheels causes the distribution element to rotate.

In accordance with one embodiment, a spreader is provided for distributing a material. The spreader includes a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame; a plurality of wheels operatively connected to the frame for traversing the spreader; a drive assembly comprising a motor operable to drive one or more of the plurality of wheels; and a battery receiving compartment configured to selectively receive a battery for powering the motor, wherein the battery receiving compartment is mounted to the frame.

In accordance with one embodiment, a spreader is provided for distributing a material. The spreader includes a hopper assembly defining a receiving area configured to hold the material, the hopper assembly comprising one or more dispersion outlets for releasing the material from the receiving area; a distribution element disposed below the one or more dispersion outlets, wherein the distribution element comprises a first elongated surface opposite a second elongated surface, and wherein each of the first elongated surface and the second elongated surface comprise one or more radial contours extending in a radial direction; a frame supporting the hopper assembly; a handle assembly connected to the frame; and a plurality of wheels operatively connected to the frame for traversing the spreader.

In accordance with one embodiment, a spreader is provided for distributing a material. The spreader includes a hopper assembly defining a receiving area configured to hold the material, the hopper assembly comprising one or more dispersion outlets for releasing the material from the receiving area; a distribution element disposed below the one or more dispersion outlets, a frame supporting the hopper assembly; a handle assembly connected to the frame; a plurality of wheels operatively connected to the frame for traversing the spreader; and, a lid rotatably coupled to the hopper assembly.

In accordance with one embodiment, a spreader is provided for distributing a material. The spreader includes a hopper assembly defining a receiving area configured to hold the material, the hopper assembly comprising one or more dispersion outlets for releasing the material from the receiving area; a distribution element disposed below the one or more dispersion outlets; a blocking plate that selectively blocks the one or more dispersion outlets; a frame supporting the hopper assembly; a handle assembly connected to the frame; a plurality of wheels operatively connected to the frame for traversing the spreader; and a deflector panel moveable between a stowed position and a deflector position, wherein when the deflector panel is in the deflector position the deflector panel partially blocks material from be spread by the distribution element.

In accordance with one embodiment, a spreader is provided for distributing a material. The spreader includes a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame; a plurality of wheels operatively connected to the frame for traversing the spreader; and a vibrator mounted to the spreader.

In accordance with one embodiment, a spreader is provided for distributing a material. The spreader includes a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame; a plurality of wheels operatively connected to the frame for traversing the spreader; a drive assembly comprising a motor operable to drive one or more of the plurality of wheels; one or more sensors configured to determine one or more operational conditions of the spreader; and a controller configured to control one or more operational parameters of the spreader based on feedback from the one or more sensors.

In accordance with one embodiment, a spreader is provided for distributing a material. The spreader includes a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame; a plurality of wheels operatively connected to the frame for traversing the spreader; a drive assembly comprising a motor operable to drive one or more of the plurality of wheels; one or more sensors configured to determine one or more operational conditions of the spreader; and a controller configured to control an operation of the motor of the spreader based on feedback from the one or more sensors.

In accordance with one embodiment, a spreader is provided for distributing a material. The spreader includes a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame comprising a bail bar; a plurality of wheels operatively connected to the frame for traversing the spreader; and a drive assembly comprising a motor operable to drive one or more of the plurality of wheels, wherein the motor only drives the one or more of the plurality of wheels when the bail bar is actuated into an engaged position.

In accordance with one embodiment, a spreader is provided for distributing a material. The spreader includes a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame, the handle assembly comprising a user interface configured to display one or more operational parameters of the spreader; a plurality of wheels operatively connected to the frame for traversing the spreader; and a drive assembly comprising a motor operable to drive one or more of the plurality of wheels.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a spreader in accordance with embodiments of the present disclosure;

FIG. 2 is a top view of the hopper assembly in an open configuration for a spreader in accordance with embodiments of the present disclosure;

FIG. 3 is partial front perspective view of a spreader in accordance with embodiments of the present disclosure;

FIG. 4 is front perspective view of a drive assembly for a spreader in accordance with embodiments of the present disclosure;

FIG. 5 is an enlarged view of the drive assembly engaging a wheel in accordance with embodiments of the present disclosure;

FIG. 6 is an interior view of the interior components of a spinner gear assembly in accordance with embodiments of the present disclosure:

FIG. 7A is a hopper assembly of a spreader illustrated in an open state in accordance with embodiments of the present disclosure;

FIG. 7B is a hopper assembly of a spreader illustrated in a closed state in accordance with embodiments of the present disclosure;

FIG. 8 is an external bottom view of a hopper assembly of a spreader in accordance with embodiments of the present disclosure;

FIG. 9A is external rear perspective of a blocking plate in a closed position in accordance with embodiments of the present disclosure:

FIG. 9B is an interior perspective of a bottom wall of a hopper assembly with the blocking plate in the closed position in accordance with embodiments of the present disclosure;

FIG. 10A is external rear perspective of a blocking plate in a partially open position in accordance with embodiments of the present disclosure;

FIG. 10B is an interior perspective of a bottom wall of a hopper assembly with the blocking plate in partially open position in accordance with embodiments of the present disclosure:

FIG. 11A is side view of a distribution element in accordance with embodiments of the present disclosure:

FIG. 11B is a cross sectional view of the distribution element installed on a spinner axle in accordance with embodiments of the present disclosure:

FIG. 12A is an external lower perspective of a battery receiving compartment in accordance with embodiments of the present disclosure:

FIG. 12B is an external upper perspective of a battery receiving compartment in accordance with embodiments of the present disclosure:

FIG. 13 is a handle assembly in accordance with embodiments of the present disclosure:

FIG. 14 is an exemplary layout of a user interface in accordance with embodiments of the present disclosure:

FIG. 15 is an interior perspective view of a handle assembly including a bail bar in accordance with embodiments of the present disclosure:

FIG. 16 is an interior top view of a handle assembly including drive paddles in accordance with embodiments of the present disclosure:

FIG. 17 is a perspective view of a dispersion hole controller for a handle assembly in accordance with embodiments of the present disclosure;

FIG. 18 is a restrictor assembly for a dispersion hole controller in accordance with embodiments of the present disclosure:

FIG. 19 is an exemplary method of operating a spreader in accordance with embodiments of the present disclosure;

FIG. 20 is another exemplary method of operating a spreader in accordance with embodiments of the present disclosure:

FIG. 21 is another exemplary method of operating a spreader in accordance with embodiments of the present disclosure; and

FIG. 22 is another exemplary method of operating a spreader in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it w-ill be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example. “generally vertical” includes directions within ten degrees of vertical in any direction, e.g., clockwise or counter-clockwise.

As used herein, the term “operably connected” refers to a mechanical and/or electrical connection between two or more elements, whether they are directly connected to one another, or are connected via one or more intermediate components, such that the mechanical or electrical output of one element is passed directly or indirectly to the operably connected second component.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, spreaders, such as walk behind spreaders, can be used to spread (e.g., distribute) material stored in a hopper across a surface (e.g., grass, garden, or the like) as the spreader is traversed over the ground. The spreaders can incorporate one or more variations to provide greater ease of use to the operator, more selective or precise operation, or otherwise assist in the consistent and safe distribution of material across an area. For instance, as disclosed herein, spreaders can include motors to provide supplemental power to the wheels and/or the distribution element that broadcasts material as it leaves the hopper. The motor can thereby provide more efficient utilization of the spreader such as on difficult terrain or when covering large areas. However, even though the motor is provided, the spreaders disclosed herein can also maintain core operational capability even when the motor is not utilized. That is, the operator may still manually push the spreader and the distribution element can still rotate.

Additional features and configurations can be incorporated into the spreader such as a frame mounted battery receiving compartment, a reversible spinner disk, a hard lid for the hopper assembly that is pivotably connected thereto, a deflector and a supplemental regulator to reduce material distribution in coordination with use of the deflector, or a vibrator to help break up material. Moreover, one or more controls features and configurations can likewise be incorporated into the spreader, such as sensors and/or controllers for sensing one or more operational conditions and controlling one or more operational parameters, or additional control mechanics involving one or more actuatable devices on the handle assembly. The multiple disclosures provided herein can further be combined with one another, either entirely in part, to provide multiple versions of spreaders with one or more various features.

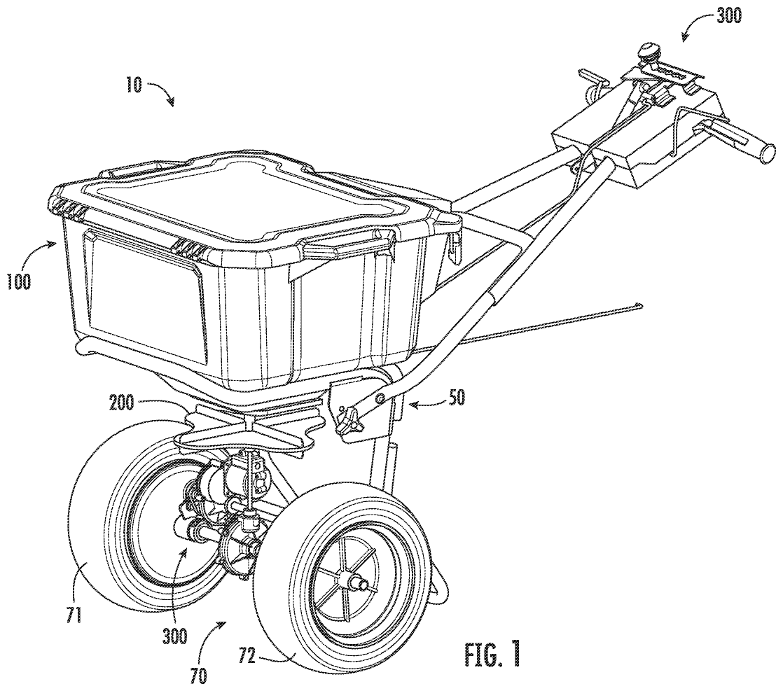

Referring now to the drawings, FIG. 1 illustrates a perspective view of a spreader 10 in accordance with an exemplary embodiment of the present disclosure.

The spreader 10 generally includes a traversing element 70 for traversing the spreader 10 over an area. For instance, as illustrated in FIG. 1, the traversing element 70 can comprise one or more wheels such as a first wheel 71 and a second wheel 72. A spreader 10 having only two wheels and no operator seat (such as illustrated in FIG. 1) can also be referred to as a walk-behind spreader. However, while the traversing element 70 is illustrated as the first wheel 71 and the second wheel 72, it should be appreciated that alternatives may also be realized, such as one or more tracks, rollers, or the like.

The spreader 10 further generally includes a frame 50 and a handle assembly 300 connected to the frame 50. The handle assembly 300 can be disposed upward and rearward from the traversing element 70. The frame 50 can be formed from tubes, plates, and the like. The elements of the frame 50 can be coupled together through weld, fasteners (e.g., threaded fasteners), or the like.

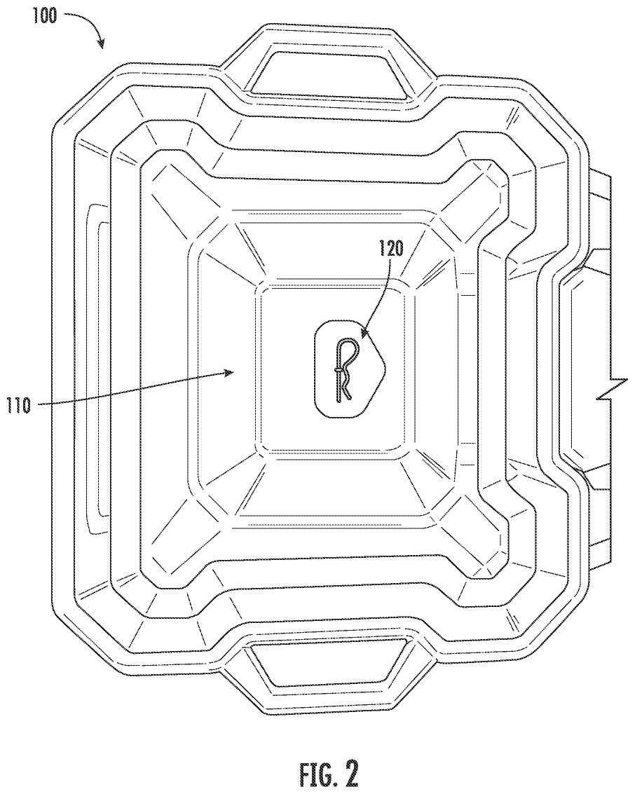

With additional reference to FIG. 2, a top view of the hopper assembly 100 is illustrated in an open configuration (i.e., with no lid). The hopper assembly 100 is disposed on the frame 50 and defines a receiving area 110 which receives a material to be broadcast by the spreader 10. The hopper assembly 100 can be formed from injection molding, roto molding, vacuum molding, or the like. In some embodiments, the hopper assembly 100 can receive at least 30 lbs of material, such as at least 40 lbs of material, such as at least 50 lbs of material, such as at least 60 lbs of material, such as at least 70 lbs of material, such as at least 80 lbs of material. The material can be granular, particulate, powder, liquid, or combinations thereof.

The hopper assembly 100 includes one or more dispersion outlets 120 for releasing the material from the receiving area 110. As disclosed herein, the hopper assembly 100 can include a variety of mechanisms and configurations for controlling the release of the material from the receiving area 110 via the one more dispersion outlets 120.

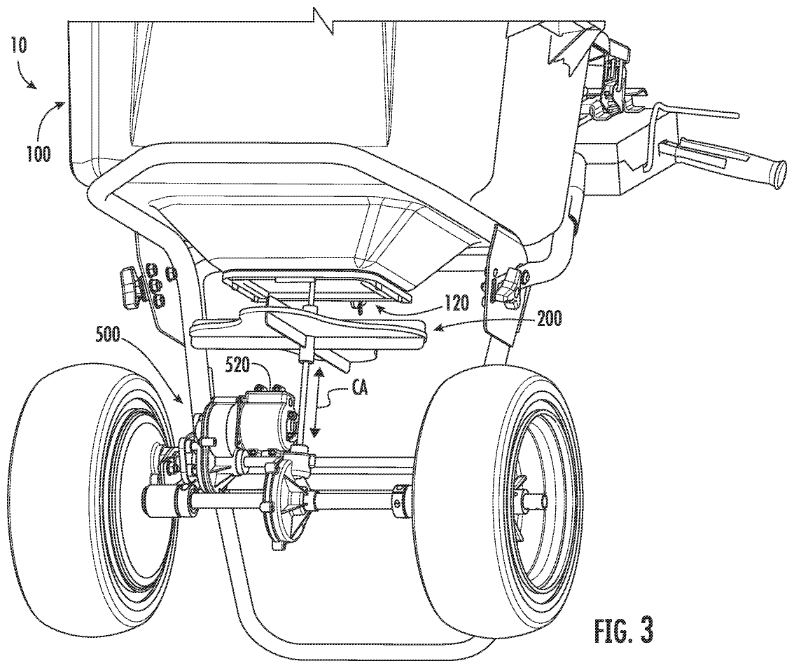

With additional reference to FIG. 3, partial front perspective view of the spreader 10 is illustrated with a focus on the underside of the hopper assembly 100. As illustrated, the spreader 10 can further generally include a distribution element 200 that can broadcast material received from the hopper assembly 100 as it exits the one or more dispersion outlets 120. The distribution element 200 can include, for example, a spinner disk disposed below the hopper assembly 100 and rotatable about a central axis CA that is orthogonal (e.g., vertical) with the ground.

As disclosed herein, one or more mechanical or electro-mechanical devices can control flow of material to the spinner disk. In some instances, the mechanical or electro-mechanical device can be controlled by the operator. In other instances, the spreader 10 can include a system, e.g., an electronic system feedback, which controls material flow based on one or more factors, such as user propulsion speed, machine pitch relative to the ground, or the like. By controlling the flow of material to the spinner disk, the mechanical or electro-mechanical device can control broadcasting of the material.

The spreader 10 can further generally include a drive assembly 500 which propels the traversing element 70 and potentially the distribution element 200. By way of non-limiting example, the motive device can include a motor 520 (such as an electric motor as illustrated), an engine, or the like. For embodiments where the motive device comprises the electric motor, the spreader 10 can further include one or more batteries (not illustrated) which provide electrical power to the electric motor. In a particular embodiment, the one or more batteries can include a single battery. In another embodiment, the one or more batteries can include a plurality of batteries. The battery or batteries may be removable, permanently installed, or a combination thereof. The batteries may also be usable on different components other than the spreader 10, such that they can be swappable between different types of tools. The electric motor can include, for example, a brushless DC motor. In some embodiments, the spreader 10 can move at a speed in a range of 0 miles per hour (MPH) and 4 MPH. In certain instances, this movement can occur in only a single direction, e.g., forward. In other embodiments, the movement can occur in two directions, e.g., forward or backwards. The spreader 10 may also be able to traverse ground (i.e., the traversing element 70 can move) even when the electric motor 520 or other motive device is not powering said movement. This can enable both manual and powered operation of the spreader, such that its is still functional even if the power source (e.g., battery) runs out or is removed.

While FIGS. 1-3 illustrate general exemplary components in accordance with one or more exemplary embodiments, the spreader 10 may further include a variety of additional or alternative embodiments. For instance, as disclosed herein, the spreader 10 can comprise one more additional or alternative configurations with respect to its drive system, its hopper assembly, and/or its control operation. However, these additional or alternative configurations disclosed herein are not mutually exclusive of one another and can be combined or removed with one another in any feasible permutation as part of the overall spreader 10.

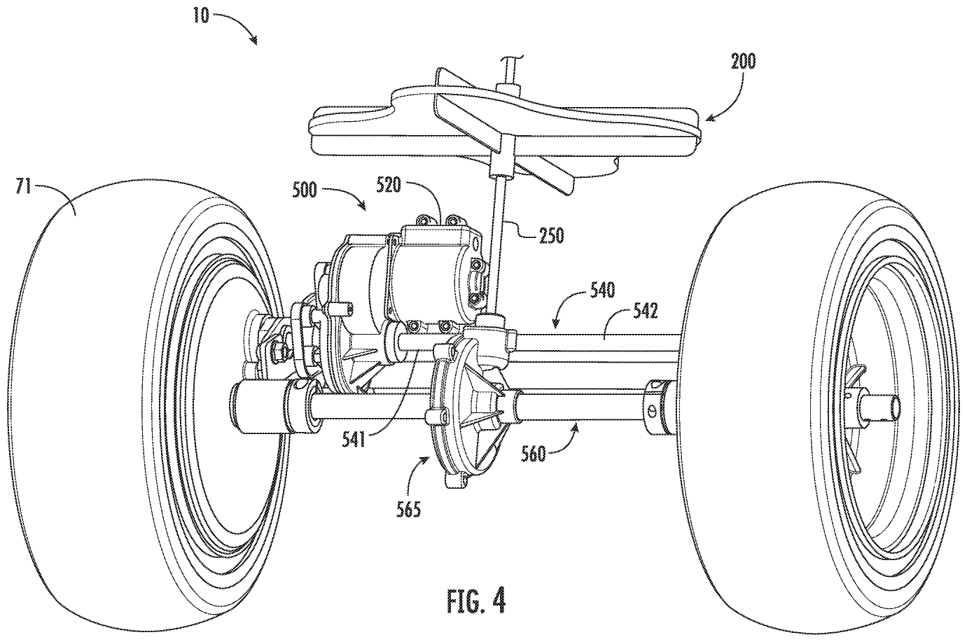

Referring now to FIG. 4, the drive assembly 500 is illustrated for the spreader 10 in accordance with an exemplary embodiment of the present disclosure.

The drive assembly 500 can be configured to enable powered propulsion of the spreader 10 through powered driving of the traversing element 70. However, the drive assembly 500 can further allow for manual (i.e., no power assist) traversal such that an operator may push the spreader 10 without the motor running. This configuration provides a spreader 10 with power assist ability but that also provides spreading functionality that is not solely dependent on the powered state of the motor and/or the presence of a suitable power source. As such, an operator may move the spreader 10 to a desired location without having to drain the power source. Additionally, the operator may continue operation of the spreader 10 even when the power source is drained. This provides operational flexibility to the operator while still incorporating selective powered propulsion.

To enable full operation of the spreader 10 with or without the use of the motor 520, the spreader 10 can comprise the distribution element 200 (e.g., a spinner disk) that can rotate to disperse the material from the hopper assembly 100 (FIG. 1) whether or not the motor 520 is driving the traversing element 70. Thus, the motor 520 may functionally drive the distribution element 200, either directly or indirectly, when the motor 520 is driving the overall spreader 10. However, even when the power source is drained or absent, for example, not only can the operator still manually push the spreader 10 while utilizing full motion of the traversing element 70 (e.g., the wheels are not locked in place due to an off-state motor), but the distribution element 200 can still rotate based off of this manual motion just as when the motor 520 is driving the traversing element 70. Thus, material from the hopper assembly 100 can still be fully broadcast via a moving (e.g., spinning) distribution element 200 whether the spreader 10 is in powered operation or manual operation.

As illustrated in FIG. 4, the drive assembly 500 provides one exemplary embodiment of enabling both powered and manual operation of the traversing element 70 and the distribution element 200. The drive assembly 500 generally comprises a motor 520 (e.g., electric motor) or other motive device operable to drive the traversing element 70. For instance, where the traversing element 70 comprises one or more wheels (e.g., first wheel 71 and second wheel 72 as illustrated), the motor 520 can be operable to drive at least one of the one or more wheels. However, as discussed above, it should be appreciated that other types of traversing elements 70 may additionally or alternatively be incorporated into the drive assembly 500, such as tracks, rollers, or the like.

The drive assembly 500 further comprises both a transmission axle 540 and a wheel axle 560. In general, the transmission axle 540 operably connects the motor 520 to at least the first wheel 71 while the wheel axle 560 operably connects the first wheel 71 to the distribution element 200 and/or the second wheel 72. Thus, mechanical power can be translated from the motor 520 to the first wheel 71 and/or the second wheel 72 via the transmission axle 540, while the first wheel 71 and/or the second wheel subsequently transmits power to distribution element 200 via the wheel axle 560.

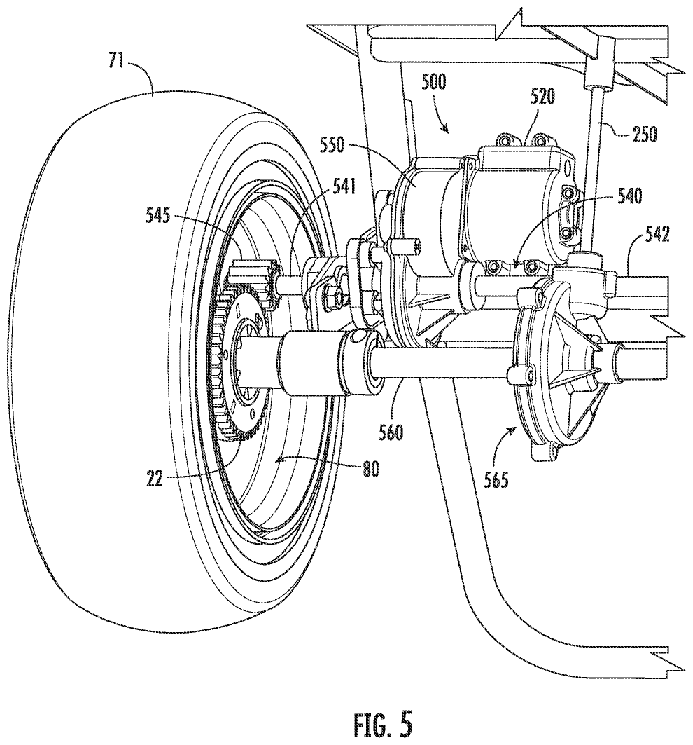

With reference to FIG. 5, an enlarged portion of the drive assembly 500 is illustrated including the interaction with the interior components of the first wheel 71. The transmission axle 540 extends at least from the motor 520 to the first wheel 71. However, in some embodiments, the transmission axle 540 may also extend from the motor 520 to the second wheel 72 (FIG. 4). For instance, the transmission axle 540 can include a first transmission axle 541 operably connecting the motor 520 (or its gearbox 550) to the first wheel 71. Likewise, the transmission axle 540 can include a second transmission axle 542 operably connecting the motor 520 (or its gearbox 550) to the second wheel 72 (FIG. 4).

With reference to the first wheel 71, the transmission axle 540 can include a motor gear 545 fixed to the transmission axle 540 (e.g., the first transmission axle 541). The first wheel 71 can include a hub 80 that includes a wheel gear 82. The wheel gear 82 and the motor gear 545 can operably couple such that rotation of the transmission axle 540 (e.g., as driven by the motor 520) causes the motor gear 545 to rotate, which in turn, causes the wheel gear 82 to rotate, which thus causes the first wheel 71 to rotate. In some embodiments, a second transmission axle 542 and the second wheel 72 may have a similar connection such that rotation of the second transmission axle 542 operably rotates the second wheel 72. However, as disclosed herein, in some embodiments, the motor may only operably rotate the first wheel 71, which then, itself, operably causes the second wheel 72 to rotate.

The drive assembly 500 can further include a gearbox 550 operably disposed between the motor 520 and the first wheel 71 and/or the second wheel 72 (or other component of the traversing element 70). The gearbox 550 can comprise one or more components to control the rotational speed and/or ability of the first wheel 71 and/or second wheel 72. For instance, the gearbox can provide multiple gears for shifting the output from the motor 520 to the first wheel 71 and/or second wheel 72 to control the speed, torque, or other operational parameter.

Moreover, the gearbox 550 may be configured to enable the first wheel 71 and/or the second wheel 72 to rotate regardless of the operational state of the motor 520. Alternatively, or additionally, the gearbox 550 may be configured to allow for over rotation of the first wheel 71 and/or second wheel 72 (e.g., when the spreader 10 is pushed or turned faster than the output of the motor 520) or backwards rotation of the first wheel 71 and/or second wheel 72 (e.g., when the spreader 10 is pulled backwards despite the motor 520 running).

For instance, the gearbox 550 may comprise a clutch that enables the selective operational engagement and disengagement between the motor 520 and the first wheel 71 and/or second wheel. Such clutch mechanisms can include, for example, centrifugal clutches. Exemplary centrifugal clutches can keep the clutch in a disengaged state (where power from the motor 520 is not transferred to the traversing element 70) until the clutch is spun fast enough by the motor 520 to create enough centrifugal force to cause one or more components in the centrifugal clutch to move into an engaged position. While in the engaged position, the centrifugal clutch transfers rotational power from the motor 520 to the traversing element 70. Such transfer of power can continue until the threshold centrifugal force dissipates (e.g., the motor stops running) such that the respective components of the centrifugal clutch return to their disengaged position.

With reference to FIGS. 4 and 5, the gearbox assembly 550 further includes the wheel axle 560. The wheel axle 560 extends between the first wheel 71 and the second wheel 72. The wheel axle 560 can be operably connected to the distribution element 200 via a spinner axle 250 connected to the wheel axle 560 via a spinner gear assembly 565. The wheel axle 560 can, for example, be fixed to the first wheel 71 and rotatably supported by the second wheel 72. Thus, only rotation of the first wheel 71 may rotate the wheel axle 560 while the second wheel 72 provides an anchoring point on its distal end while still enabling rotation. Alternatively, the wheel axle 560 may be fixed to both the first wheel 71 and the second wheel 72 such that the first wheel 71, second wheel 72, and wheel axle 560 all rotate in unison at all times.

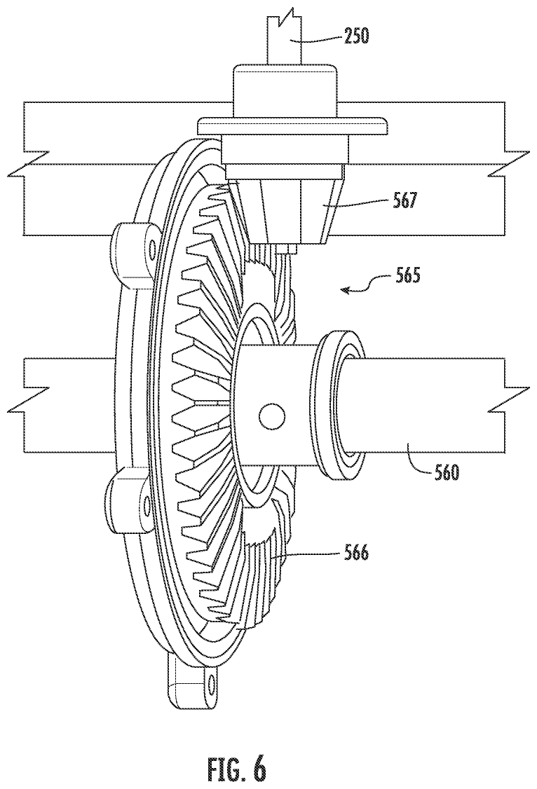

With additional reference to FIG. 6, the interior components of a spinner gear assembly 565 is illustrated. That is the spinner gear assembly 565 can include a first component 566 fixed to the wheel axle 560 that rotates therewith. The rotation of the first component 566 can cause rotation of a second component 567 that is perpendicular with the first component 566. The second component 567 can be fixed to the spinner axle 250 which is in a substantially orthogonal (e.g., vertical) orientation with the ground when the spreader 10 is in the operating position. Last, the distribution element 200 (FIG. 4) can be fixed to the spinner axle 250 such that the two components spin together. Cumulatively, rotation of the wheel axle 560 (as driven by the traversing element 70 to which the wheel axle 560 is affixed), is thereby translated into rotation of the distribution element 200. Thus, by keying rotation off of the wheel axle 560, as opposed to the transmission axle 540, the distribution element 200 can rotate whether the spreader 10 is operated in a manual or powered mode. This flexibility provides full core functionality of the spreader 10 to the operator even when the power source is drained, absent, or otherwise nonfunctional.

In some embodiments, the wheel axle 560 may transfer power from the first wheel 71 to the second wheel 72 by being fixed to both elements. That is, rotation of the first wheel 71 can subsequently drive rotation of the second wheel 72 via the intermediate wheel axle 560. Such embodiments may include when the transmission axle 540 only includes a first transmission axle 541 to transfer power from the motor 520 to the first wheel 71, but lacks a second transmission axle 542 to transfer power directly from the motor 520 to the second wheel 72.

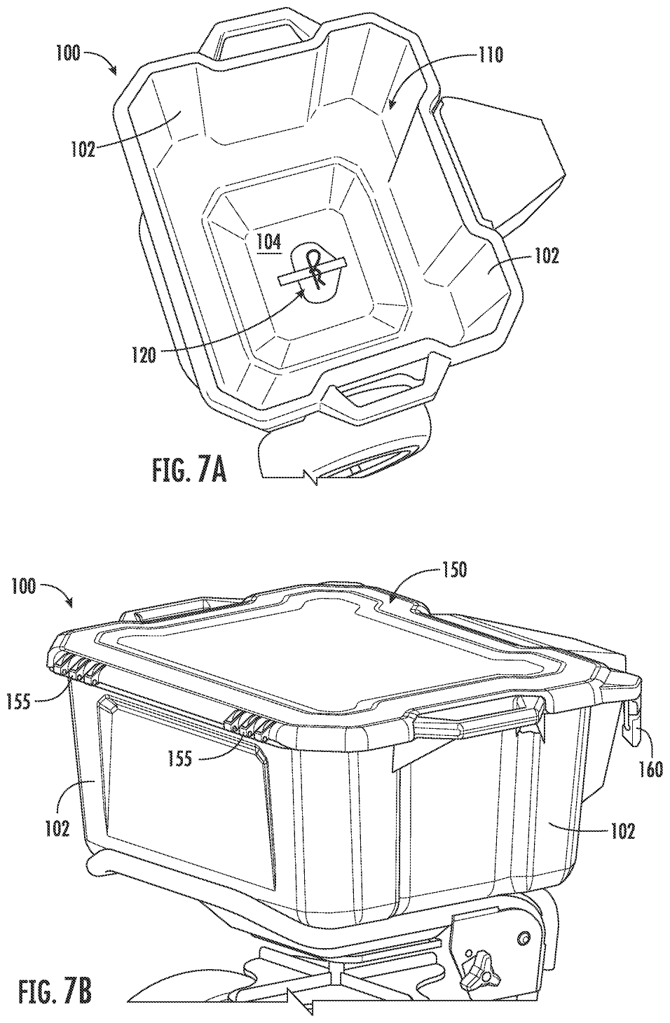

Referring now to FIGS. 7A and 7B, the hopper assembly 100 is illustrated for the spreader 10 (FIG. 1) in both an open state (without at lid as illustrated in FIG. 7A) and in a closed state (with a lid as illustrated in FIG. 7B) in accordance with an exemplary embodiment of the present disclosure.

The hopper assembly 100 generally defines a receiving area 110 configured to hold the material (not illustrated) that is to be spread. For instance, a plurality of side walls 102 can extend from a bottom wall 104 to define a partially enclosed cavity that forms the receiving area 110. In some embodiments, the one or more side walls 102 may be sloped inwards as they approach the bottom wall 104. Additionally, or alternatively, the bottom wall 104 may have a central recess 105 that that defines the bottom portion of the receiving area 110. Such embodiments can ensure the material is fed to and consolidated at the bottom of the receiving area 110 to ensure as much of the material as possible can exit the hopper assembly 100. The hopper assembly 100 can further comprise an open at its top portion. The opening can be used to fill the receiving area 110 with material such as before using the spreader 10.

As best illustrated in FIG. 7B, in some embodiments, the hopper assembly 100 includes a lid 150. The lid 150 can selectively be disposed at the top of the hopper assembly to close, or at least partially close, the receiving area 110. Having the lid 150 in a closed position (such as illustrated in FIG. 7B), can prevent moisture, debris, or other unwanted material from entering the receiving area 110, such as when material to be spread (e.g., fertilizer) is contained therein. Likewise, the lid 150 in the closed position can prevent the material in the receiving area 110 from unintentionally exiting the receiving area 110 such as when the spreader 10 traverses over bumps or is knocked over on its side.

In some embodiments, the lid 150 may comprise a rigid material such as a rigid plastic material. Such embodiments can provide a sturdier construction and protection mechanism for the receiving area 110. Moreover, in some embodiments, the lid 150 can be rotatably coupled to the hopper assembly 100. For instance, as illustrated in FIG. 7B, the lid may comprise one or more pivotable connections 155 that secure the lid 150 to one or more side walls 102 of the hopper assembly 100 via a rotatable connection. Such embodiments can allow for the operator to access the receiving area 110 without having to completely separate the lid 150 from the hopper assembly 100, potentially leading to its misplacement.

To secure the lid 150 in the closed state, the lid 150 may comprise one or more latches 160. The one or more latches 160 can latch the lid into a closed position by anchoring onto one or more locations of the hopper assembly 100, such as a lip or exterior surface of one or more side walls 102.

The hopper assembly 100 may have one or more sensors that can be incorporated into the operation of the overall spreader 10. For instance, the hopper assembly 100 may comprise a lid sensor (not illustrated) that can detect when the lid 150 is closed. In some embodiments, the lid sensor can include a hall sensor. In such embodiments, a magnet may be disposed in the lid, and a hall sensor may be disposed proximate the receiving area 110 (such as on the lip of one or more side walls 102) such that the hall sensor detects when the magnet on the lid 150 is nearby and thus the lid 150 is in a closed position. Alternatively, the magnet and the hall sensor may be disposed in opposite positions. In some embodiments, the lid sensor may be a pressure sensor that detects pressure when the lid 150 is closed. In even some embodiments, the lid sensor may be a photovoltaic sensor that senses the lack of light in the receiving area 110 when the lid 150 is closed. While certain sensors are disclosed herein, it should be appreciated that alternative sensors may also be realized for detecting the closed position of the lid 150.

The feedback from the lid sensors can be utilized for the operation or control of the spreader 10. For instance, the motor 520 (FIG. 1) of the spreader 10 may only operate when the lid is detected in a closed position. This may prevent accelerated rotation of the spreader and/or the distribution element 200 (e.g., spinner disk) to avoid unintended material passing through the hopper assembly and contacting the same. Alternatively, or additionally, the spreader 10 may cease operation (e.g., stop the motor) when a lid-opening event is detected. Further, the spreader 10 may prevent the opening of the dispersion outlets 120 when the lid 150 is open.

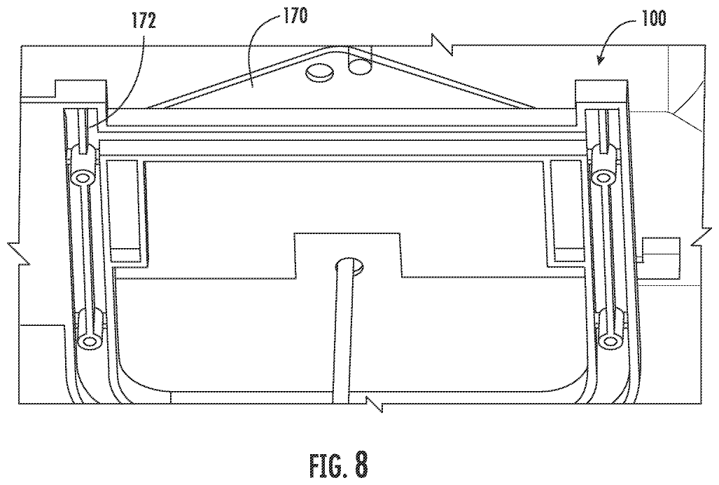

With additional reference to FIG. 8, the external bottom side of the hopper assembly 100 is illustrated. As collectively seen between FIGS. 7A and 8, the hopper assembly 100 includes a blocking plate 170 that selectively blocks the one or more dispersion outlets (hidden behind the blocking plate 170 in FIG. 8) so that material in the receiving area does not exit the hopper assembly 100 unless the blocking plate 170 is moved away from its closed position. It should be appreciated that while the blocking plate 170 is illustrated on the exterior of the hopper assembly in FIG. 8, all or part of the blocking plate 170 may additionally or alternatively be disposed on the interior of the hopper assembly 100 such as directly on top of the bottom wall in the receiving area.

The blocking plate 170 can comprise any suitable element that effectively closes of the one or more dispersion outlets when in the closed position. As illustrated in FIG. 8, the blocking plate 170 can be mounted to a track 172 that guides the blocking plate between the closed and open positions. For instance, the blocking plate can laterally move between the closed and open positions as guided by the track 172.

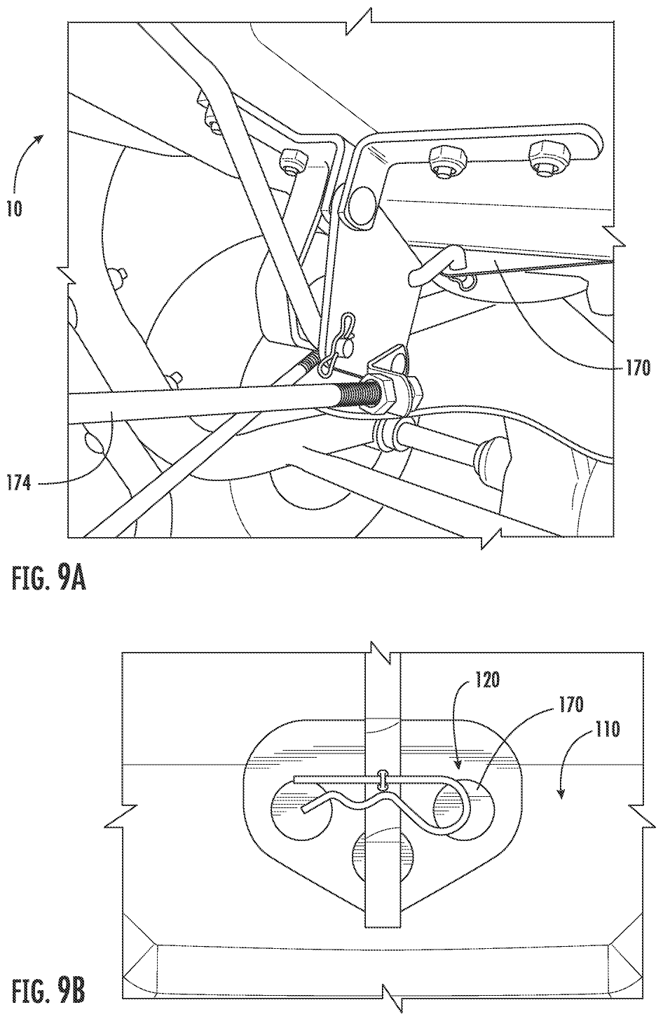

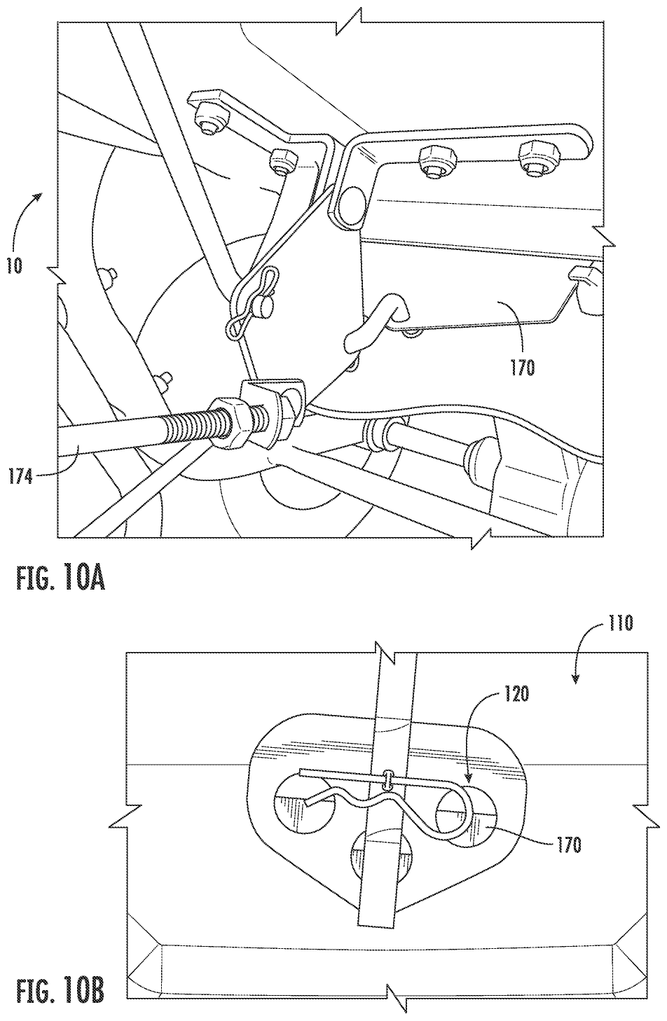

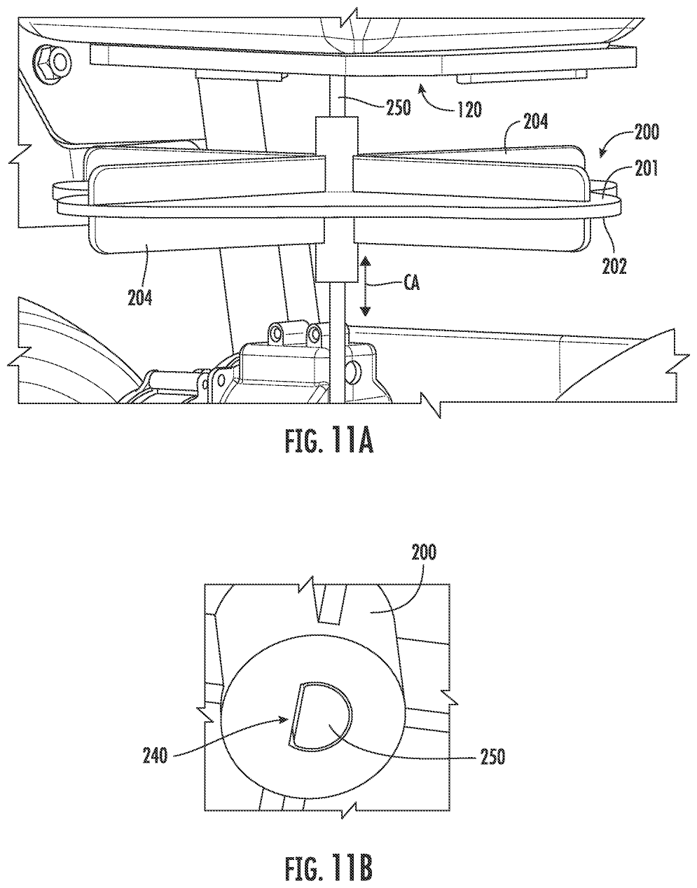

With reference to FIGS. 9 and 10, the blocking plate 170 is illustrated transitioning from a closed position (FIGS. 9A and 9B) to a partially open position (FIGS. 10A and 10B). With reference to FIGS. 9A and 9B, the blocking plate 170 is illustrated in the closed position from a perspective that is behind and external the spreader 10 (FIG. 9A) and from a perspective from within the receiving area 110 of the hopper assembly 100 (FIG. 9B). As illustrated, the blocking plate 170 is disposed in the close position to block the three dispersion outlets. The blocking plate is operably connected with an arm 174 that extends towards the handle (not illustrated) of the spreader 10.

With reference to FIGS. 10A and 10B, the blocking plate 170 is illustrated in the partially open position from a perspective that is behind and external the spreader 10 (FIG. 10A) and from a perspective from within the receiving area 110 of the hopper assembly 100 (FIG. 10B). That is, as the operator actuates the arm 174, the blocking plate 170 slides backwards along the track 172 to slowly open up the one or more dispersing outlets 120. The more the arm 174 is actuated, the more the blocking plate 170 moves and the more open the one or more dispersing outlets 120 become. Thus, the amount of material exiting the hopper assembly 100 can be selectively controlled by the opening and closing of the dispersing outlets 120 via actuation of the arm 174.

In addition to the blocking plate, in some embodiments, a subset (e.g., one) of the one or more dispersion outlets 120 may have a supplemental regulator configured to selectively reduce the size of the opening. That is, the supplemental regulator can control the relative size of a subset of the one or more dispersion outlets 120 to provide an alternative or supplemental means of controlling the amount of material flow out of the hopper assembly 100. For instance, even when the blocking plate 170 is in a fully open position such that all of the one or more dispersion outlets 120 are fully open, the supplemental regulator can reduce a subset to of the one or more dispersion outlets 120 to at least throttle down material flow.

In some embodiments, the hopper assembly 100 may comprise a deflector panel. The deflector panel can comprise an element that partially blocks material from being spread to a certain area with respect to the overall spreader 10. For instance, when an operator is traversing the spreader directly adjacent a garden, the operator may wish to broadcast fertilizer directly below and to the first side of the spreader, but not to the second side of the spreader that constitutes the garden. As such, the deflector may block material being broadcast from going to the respective side of the spreader 10. In some embodiments, the deflector may be pivotably attached to the hopper assembly 100 and thus movable (e.g., pivotably) between a stowed position (that offers no interruption of the broadcast material) and a deflector position (that at least partially deflects or blocks material from being spread to a certain area). Alternatively, the deflector may be slidably attached to the hopper assembly and thus slidably movable between the stowed and deflector positions.

In even some embodiments, movement of a deflector panel may be integrated with movement of a supplemental regulator. For instance, as the deflector panel transitions from a stowed position to a deflector position, the supplemental regulator may automatically restrict the opening of a subset of the one or more dispersion outlets 120. Likewise, as the deflector is returned to the stowed position to allow for full broadcast ability, the supplemental regulator may return to a fully opened position that provides no restriction to the one or more dispersion outlets 120. Such embodiments may provide coordinated and automatic material distribution throttling when an operator engages and disengages a deflector. That is, through a single operation action (e.g., engaging the deflector), the deflector can come down to partially block material distribution; however, the one or more dispersion outlets 120 will also automatically be restricted to limit the flow of material at the same time via the coordinated movement of the supplemental regulator. This can prevent an oversaturation of material onto a now reduced footprint of ground by automatically reducing the amount of material being spread.

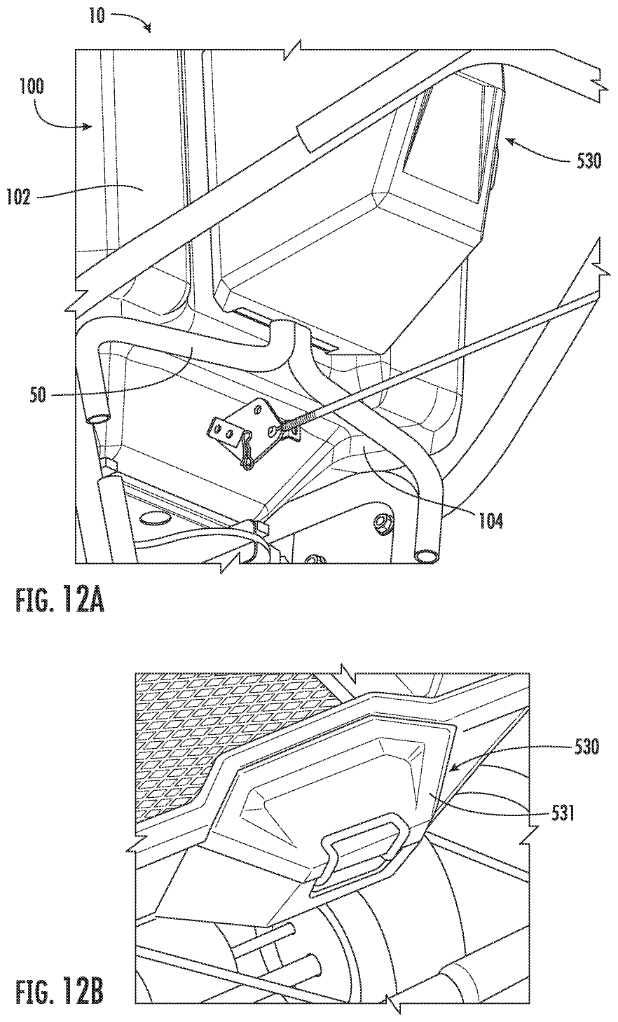

With reference to FIG. 11A, a distribution element 200 is illustrated for receiving material exiting the one or more dispersing outlets 120 and spreading it around the area the spreader 10 is traversing over. The distribution element 200 can comprise a variety of shapes and configurations. For instance, the distribution element 200 can comprise a substantially cylindrical disk or a symmetrical disk with one or more variations in the circumference (e.g., fan-shaped).

The distribution element 200 may further comprise one or more radial contours 204. The radial contours 204 can be raised or recessed features to help guide the material being dispersed with the distribution element 200 is rotating. For instance, as illustrated in FIG. 11A, the distribution element 200 can comprise four radial contours 204 radially extending from the central axis to the outer perimeter.

The distribution element 200 can rotate about a central axis CA that is substantially perpendicular to the ground (i.e., vertical) when the spreader is in the operating position. As such, material that is received on the distribution element 200 can be thrown off the distribution element 200 due to centrifugal force caused by its rotation.

With reference to FIG. 11B, a cross sectional view of the distribution element 200 installed on a spinner axle 250 is illustrated. That is, the distribution element 200 can comprise a central passage 240 that receives the spinner axle 250. The central passage 240 and the spinner axle 250 can share a complimentary shape such that the spinner axle 250 pages with the central passage as illustrated. Moreover, the central passage 240 and the spinner axle 250 can each comprise a non-circular cross section configuration. For instance, the central passage 240 can comprise a substantially semi-circular configuration as illustrated. The non-circular configuration provides driving contact points between the spinner axle 250 and the distribution element 200 in the central passage 240. As such, rotational movement of the spinner axle 250 drives the distribution element 200 to rotate, as opposed to the spinner axle 250 freely rotating within the central passage 240.

In some embodiments, such as that illustrated in FIG. 11A, the distribution element 200 can comprise a reversible distribution element 200. The reversible distribution element includes a first elongated surface 201 opposite a second elongated surface 202. Either the first elongated surface 201 or the second elongated surface 202 faces the one or more dispersion outlets 120 of the hopper assembly 100 when installed. As such, the first elongated surface 201 or the second elongated surface 202 receives material exiting the hopper assembly 100, then broadcasts said material onto the ground while the distribution element 200 rotates.

However, both the first elongated surface 201 and the second elongated surface 202 can be utilized for broadcasting such that the distribution element 200 can be installed in either an upward or downward configuration wherein either the first elongated surface 201 or second elongated surface 202 face the one or more dispersion outlets 120. For instance, both the first elongated surface 201 and the second elongated surface 202 may be a planar surface. Such embodiments prevent concave or convex configurations.

Alternatively, or additionally, both the first elongated surface 201 and the second elongated surface 202 may comprise one or more radial contours 204. For instance, the first elongated surface 201 may comprise a first plurality of radial contours and the second elongated surface 202 may comprise a second plurality of radial contours. In some embodiments, the first plurality of radial contours may have a common configuration (i.e., same number of contours, size, and shape) as the second plurality of radial contours. However, in some embodiments, the first plurality of radial contours may have a different configuration (i.e., different number of contours, different sized contours, and/or different shaped contours) than the second plurality of radial contours.

With reference now to FIGS. 12A and 12B, a battery receiving compartment 530 on the hopper assembly 100 is illustrated from a lower perspective (FIG. 12A) and an upper perspective (FIG. 12B). The battery receiving compartment 530 is configured to selectively receive a battery, such as a rechargeable battery, for powering the motor 520 (FIG. 1) or other motive device. The battery receiving compartment 530 can comprise an enclosed compartment with a battery lid 531 configured to transition between an open position and a closed position. That is, the battery lid 531 can be selectively opened to install and remove one or more batteries. Once installed, the battery lid 532 may be closed to prevent outside debris, liquid, or other unwanted material from entering the interior of the battery receiving compartment 530.

As best illustrated in FIG. 12A, the battery receiving compartment 530 can be mounted to the frame 50 of the spreader 10. By mounting the battery receiving compartment 530 to the frame 50, the weight of the battery receiving compartment 530 does not pull on the hopper assembly 100 itself or other lighter weight and less sturdy components. In some embodiments, the battery receiving compartment 530 may be mounted to both the frame 50 and the hopper assembly 100. In some embodiments, the battery receiving compartment 530 may be mounted solely to the frame 50. In some embodiments, the battery receiving compartment 530 may not have any direct mounting connection to the walls (e.g., side walls 102 or bottom wall 104) of the hopper assembly 100.

As illustrated in FIG. 12A, in some embodiments, the battery receiving compartment 530 can be mounted to the frame 50 at a location behind the hopper assembly 100. That is, the battery receiving compartment 530 may be located between the hopper assembly 100 and the handle assembly 300 (FIG. 1). Such embodiments may provide balanced weight distribution for the overall spreader 10. Moreover, said mounting position may also provide convenient physical access for the operator to the battery receiving compartment 530 for the installation and removal of batteries. Further, the location behind the hopper assembly 100 may provide visual access of the battery receiving compartment 530 by the operator while operating the spreader 10 via the handle assembly 300, such as to observe visual indicators on the battery receiving compartment 530 regarding batter life or the like.

In some embodiments, the battery lid 531 may comprise a latch to keep the battery lid 531 in a closed position. In some embodiments, the battery lid 531 may sealingly engage with the battery receiving compartment 530 when in the closed position. For instance, a gasket, O-ring, or other sealing element may be disposed between the battery lid 531 and the battery receiving compartment 530. Thus, the sealing element can be compressed to form a seal for prevent outside material from entering the battery receiving compartment 530. In some embodiments, the battery receiving compartment 530 may be spring loaded. That is, one or more springs may be disposed inside battery receiving compartment 530 for receiving and exiting the removable battery. When the battery is installed, the one or more springs may be compressed such that the battery is biased in an exiting direction. Thus, once the battery lid 531 is opened, the battery may be naturally biased to partially exit the battery receiving compartment 530 to provide easier gripping or access for full removal. Alternatively, the battery may stay in its recessed position with a compressed spring until a user pushes the batter further to actuate and then release the batter storing mechanism.

With reference back to FIGS. 7A and 7B, the spreader 10 may include one or more supplemental components for facilitating the flow of material through the one or more dispersion outlets 120 when said dispersion outsets 120 are open. For instance, the spreader 10 may comprise one or more mechanical arms, racks, stirrers or the like to shift the material stored in the receiving area 110 of the hopper assembly 100.

In some embodiments, the hopper assembly 100 may comprise a vibrator. The vibrator can be configured to vibrate the material disposed in the receiving area 110 of the hopper assembly 100. The application of vibrations can help break up clumps, clogs, or otherwise help promote the flowability of the material out of the hopper assembly 100. The vibrator may be mounted to one or more of the side walls 102 or bottom wall 104 of the hopper assembly 100, or mounted to the frame 50 in a way that passes the vibrations from the frame 50 to the hopper assembly 100. In some embodiments, the vibrator may be mounted in the receiving area 110 of the hopper assembly 100 such that it can make direct contact with material disposed therein. In some embodiments, a plurality of vibrators may be mounted to the hopper assembly 100.

The vibrator may be selectively activated by an operator, may be automatically activated based on pre-set routines, may be automatically activated based on sensed conditions or combinations thereof. For instance, the handle assembly 300 (FIG. 1) may comprise an activation trigger for activating the vibrator. Alternatively, or additionally, the spreader 10 may comprise a controller configured to control one or more operational parameters of the spreader 10, such as activation and deactivation of the vibrator. In such embodiments, the controller may activate the vibrator based on a variety of potential automatic or sensed conditions. For instance, the controller may automatically activate the vibrator at preset or user-defined intervals (e.g., every 30 seconds, 1 minute, or 2 minutes). Alternatively, or additionally, the controller may selectively activate the vibrator when one or more conditions are determined such as a reduced outflow of material, a detection of clumps, an accelerated speed of the spreader, or other potential variables. The vibrator may be powered by the same power source as used for the motor. For instance, the battery stored in the battery receiving compartment (FIGS. 12A and 12B) may be used to power both the motor 520 (FIG. 1) and the vibrator, in addition to any other supplemental components (e.g., processors, displays, or the like).

Referring now to FIG. 13, a handle assembly 300 is illustrated for the spreader 10 (FIG. 1) in accordance with an exemplary embodiment of the present disclosure. The handle assembly 300 can be affixed to one or more elongated arms 55 extending away from the hopper assembly 100 (FIG. 1). The handle assembly 300 thereby provides an operator a means for operating, controlling, steering, or otherwise manipulating one or more aspects of the spreader 10 during operation.

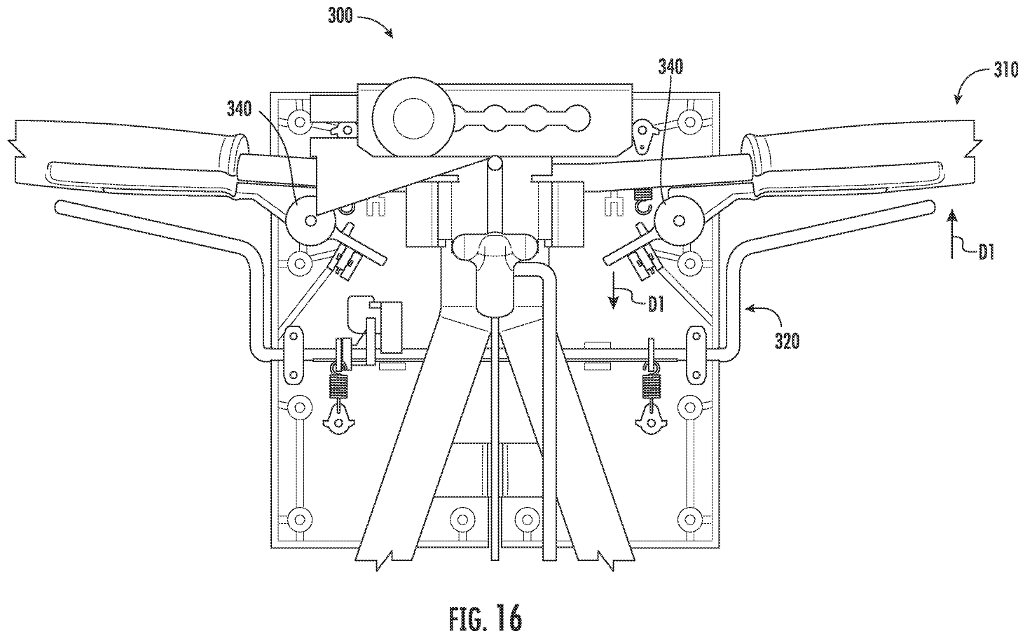

As illustrated in FIG. 13, in some embodiments, the handle assembly 300 can comprise a plurality of handles 310 such as a left handle 311 and a right handle 312. The handle assembly 300 may further comprise one or more operational actuators such as a bail bar 320, drive paddles 340 (FIG. 16), dispersion hole controller 360, additional controls 380, and even a user interface 400. As will be disclosed herein, these respective components can operate in coordination with one another, independent of one another, or combinations thereof.

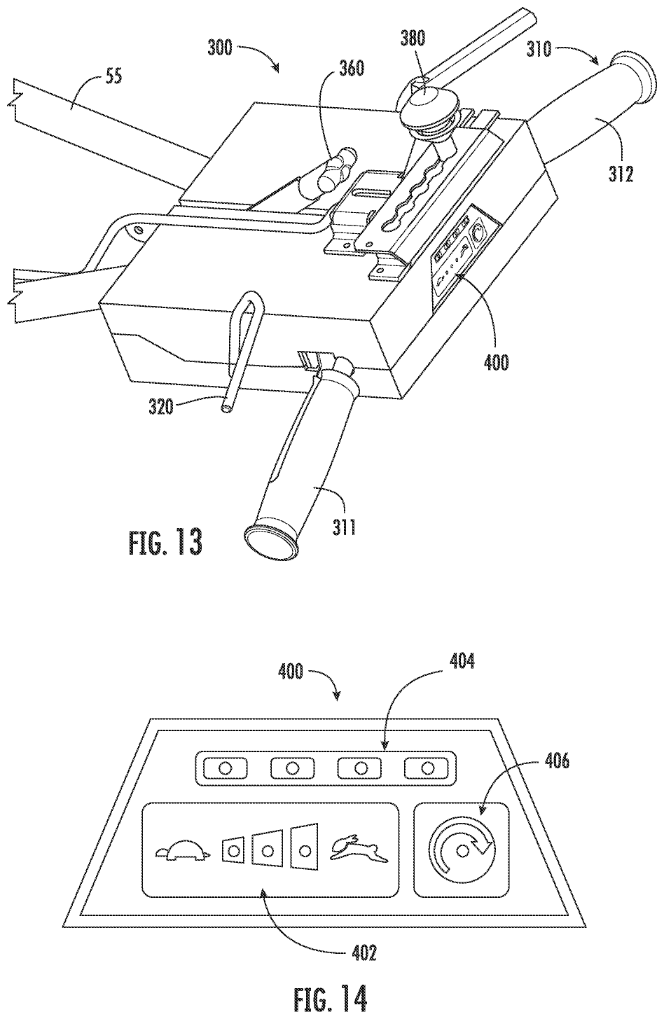

Referring now to FIG. 14, an exemplary layout of a user interface 400 is illustrated. The user interface 400 can display one or more operational parameters of the spreader 10 (FIG. 1) and/or enable user selection of one or more operational parameters. For instance, the user interface 400 may include a speed selection 402, a battery gauge 404, an arming button 406 (e.g., starter button) or combinations thereof.

The speed selection 402 may display and or allow for user selection of the traversal speed of the spreader 10 under powered conditions. For instance, the spreader 10 (FIG. 1) may provide a plurality, but a limited amount, of preset speeds, or otherwise provide for a user to select a defined speed for continuous operation. By providing and controlling set speeds, the user can operate the spreader 10 at a consistent rate while traversing ground, thereby promoting an event amount of material distribution over an elongated area. That is, selected, displayed, and controlled speed controls prevent a user from vary the speed during operation, which could increase and decrease the amount of material distributed at different respective areas.

The battery gauge 404 can display the remaining charge of the battery when installed in the battery receiving compartment (FIGS. 12A and 12B). For instance, the battery gauge 404 can display a battery life percentage, either numerically or symbolically, or display the amount of run time remaining, such as using the current speed selection.

The arming button 406 can place the motor in an active or unactive state fur subsequent engagement through additional controls. For instance, the spreader 10 may require the arming button be activated to an “armed” mode before subsequent driving controls can be activated as will be appreciated herein. Alternatively, or additionally, the arming button 406 may enable the driving of the spreader via the motor after the speed is selected via the speed selection 402 of the user interface.

While certain operational parameters are disclosed herein for display or control via the user interface 400, it should be appreciated that these are non-limiting and other aspects may also be incorporated within the scope of this disclosure. For instance, the user interface may also display or enable the selection of the type of material in the hopper, the type of terrain, the rotation speed or ability of the distribution element (e.g., spinner disk), the opening, closing or size of the dispersion outlets of the hopper assembly, or the operation of auxiliary lights. Moreover, the user interface 400 may display or enable the connection of the spreader 10 to one or more other devices such as a phone via a Bluetooth or other suitable connection.

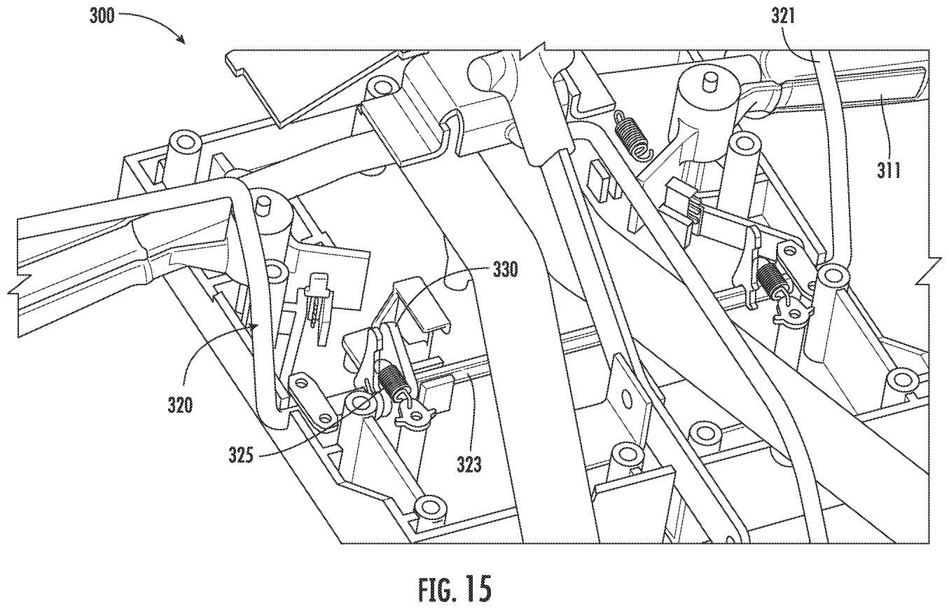

With reference to FIG. 15, an interior perspective view of the handle assembly 300 is illustrated including a bail bar 320. The bail bar 320 is configured to allow for the selective activation of the motor 520 (FIG. 1) for powering the spreader 10. That is, actuation of the bail bar can be used for the driving and stopping of the motor 520, or as a required first-step in a multi-step action for driving the motor 520.

For instance, as illustrated in FIG. 15, the bail bar 320 can include a left extension 321 and a right extension 322 joined by a central connection 323. The left extension 321 and the right extension 322 can substantially align with the left handle 311 and the right handle 312 of the handle assembly 300.

The bail bar 320 can be biased, such as via one or more springs 325, to remain in a disengaged state wherein the bail bar is rotated to a distal position away from the handles 310. However, an operator may rotate the bail bar 320 into an engaged position by pulling the bail bar 320 towards the handles 310. For instance, the left handle 311 and right handle 312 may each contain recesses 315 for receiving the left extension 321 and the right extension 322 of the bail bar 320, respectively. When the bail bar 320 is in the engaged position, one or more sensors 330 may detect the positional change and signal, or otherwise enable, the motor 520 to operate, either directly, or based on one or more additional downstream processes.

The sensors 330 can include any device operable to detect the position of the bail bar 320. For instance, in some embodiments, the sensors 330 may include a hall sensor, wherein a magnet on or connected to the bail bar 320 is drawn towards the sensors 330 when the bail bar 320 is moved to the engaged position. Alternatively, or additionally, the sensors 330 may include a pressure sensor, contact sensor, or any other suitable device.

In some embodiments, activation of the bail bar 320 simply enables the motor 520 to operate when another component is actuated (e.g., drive paddles 340 as disclosed herein and illustrated in FIG. 16). For instance, actuation of the other component may only cause the motor 520 to operate when the bail bar 320 is actuated. If said component is activated when the bail bar 320 is still in the disengaged position, the motor 520 will take no action.

In some embodiments, the bail bar 320 may be the second of only two required steps to enable the motor 520 to operate. For instance, after a starter button 406 and/or speed selection 402 (FIG. 14) are actuated, the motor may be in a ready state, albeit not a driving state. Subsequent actuation of the bail bar 320 into the engaged position may thereby signal or otherwise cause the motor 520 to start driving the spreader 10.

In some embodiments, the bail bar 320 may be the second of three or more required steps to enable the motor 520. For instance, the operator may have to arm the spreader 10 and/or select a speed for the spreader 10 via the user interface 400 (FIG. 14). Then, the user may have to actuate the bail bar 320 into the engaged position for the motor to become fully ready. Only then, may the operator actuate yet another component (e.g., drive paddles 340 as disclosed herein) before the motor 520 to start driving the spreader 10.

With reference to FIG. 16, an interior top view of the handle assembly 300 is illustrated including one or more drive paddles 340. The drive paddles 340 may facilitate the operation and control of one or more components of the spreader 10 such as the motor 520 (FIG. 1). For instance, as illustrated in FIG. 16, the handle assembly 300 may include multiple drive paddles 340 such as a left drive paddle and right drive paddle 342. The motor 520 may be activated when either of the two drive paddles 340 are actuated, or when both of the two drive paddles 340 are actuated.

In some embodiments, the drive paddles may be actuated in a direction that is different than the actuation direction of the bail bar 320. For instance, the bail bar must be actuated in a first direction D1 to move into the engaged position while the drive paddles 340 must be actuated in a second direction D2 to move into the engaged position, wherein the first direction D1 and second direction D2 are different. As illustrated in FIG. 16, the first direction can be towards the handles 310 and the second direction D2 can be away from the handles 310. For instance, whereas the bail bar 320 may be actuated by an operator gripping the bail bar 320 towards the handles 310, the drive paddles 340 by an operator's thumbs pushing the drive paddles 340 away from the handles 310.

As disclosed herein, in some embodiments, the drive paddles 340 may only activate the motor 520 when the bail bar 320 is actuated, the desired speed selected, and/or when the overall spreader 10 is armed. For instance, when the operator selects a desired speed for the spreader (e.g., using speed selection 402 of the user interface 400 (FIG. 14), then activation of one or both drive paddles 340 may cause the motor 520 to drive the spreader 10 at the selected speed. In other embodiments, the speed of the spreader 10 may be based on the amount of actuation of one or both drive paddles 340. For instance, the farther one or both drive paddles 340 are depressed, the faster the spreader 10 may be driven by the motor 520.

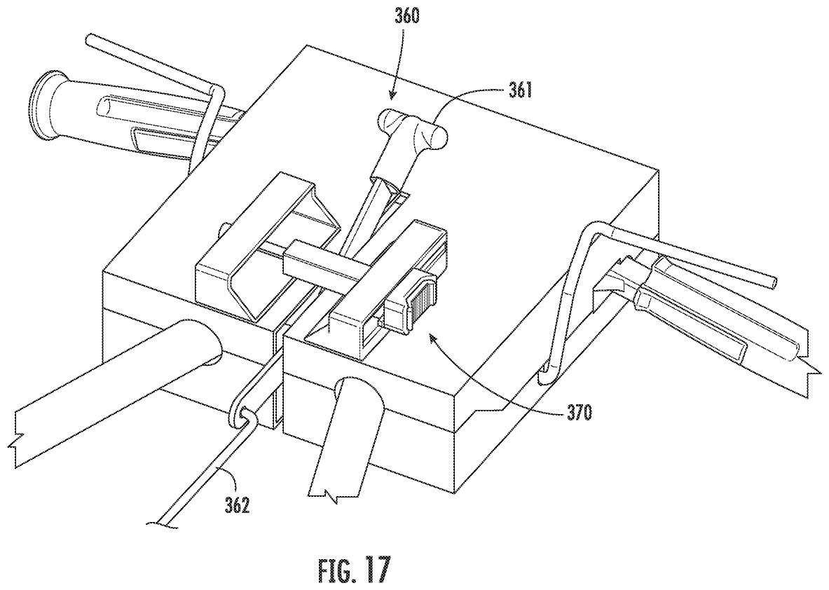

With reference to FIG. 17, a perspective view of a dispersion hole controller 360 for a handle assembly 300 is illustrated. The dispersion hole controller 360 can be operatively connected to the blocking plate 170 (FIGS. 8-10) via a connection rod 362 to control the movement thereof. That is, the dispersion hole controller 360 can comprise a handle 361 for forward and backwards actuation. When the handle 361 is pushed forward, the connection rod 362 pulls the blocking plate 170 backwards to open the one or more dispersion outlets 120. Conversely, when the handle is pulled backwards, the connection rod 362 pushes the blocking plate 170 forward to block the one or more dispersion outlets 120. As such, the dispersion hole controller 360 provides material flow controls independent of the motor actuation or speed selection. This also enables material flow control when an operator is manually using the spreader without motorized power.

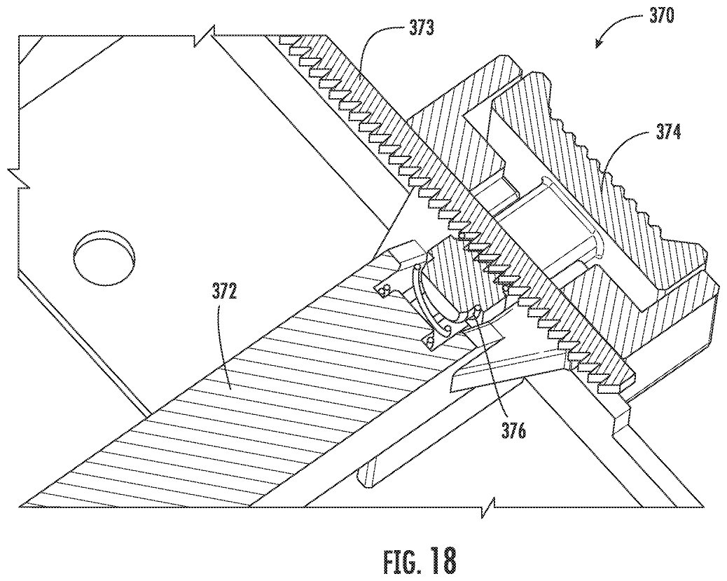

With additional reference to FIG. 18, a restrictor assembly 370 is illustrated for the dispersion hole controller 360. The restrictor assembly 370 is configured to limit actuation movement of the handle 361, thereby controlling the amount that the one or more dispersion outlets 120 are opened.

The restrictor assembly 370 can include a blocker 372 that is selectively positioned to limit the full actuation range of the handle 361 of the dispersion hole controller 360. For instance, the blocker 372 can be selectively positioned along a track 373. A spring 376 may bias the blocker 372 into a set position along the track. A button 374 may be depressed to compress the spring 376 to allow for movement of the blocker 372 along the track 373. Thus, an operator may depress the button 374, slide the blocker 372 along the track 373 while keeping the button 374 depressed until the desired position is reached, and then release the button 374 so that the spring 376 can expand and hold the blocker 372 in place along the track 373.

As illustrated in FIG. 17, the closer the blocker 372 is moved towards the operator (and farther up towards the top of the handle assembly 300, the less the handle 361 of the dispersion hole controller 360 can move. As such, that closer the blocker 372 is towards the operator, the smaller the dispersion outlets 120 can be opened and the less material can be spread. Conversely, the farther the blocker 372 is moved away from the operator, the more the handle 361 can move and the larger the dispersion outlets 120 can be opened and thus, the greater the amount of material can be spread.

As disclosed herein the overall spreader 10 (e.g., FIG. 1) may further include a controller configured to control one or more operational parameters of the spreader 10. The controller may be located in the handle assembly 300 (e.g., FIG. 13) or in any other location suitable for receiving information, processing results, and outputting control mechanisms. The operational parameters can include, for example, the power state of the spreader, the speed of the spreader, or the material distribution amount of the spreader

Moreover, the spreader 10 may include one or more sensors to determine various operational conditions of the spreader 10. For instance, the spreader 10 can include an inertial motion unit, a tilt sensor, a speed sensor, a hall sensor, a pressure sensor, a photovoltaic sensor, or a variety of other sensors.

An inertial motion unit, also referred to as an “IMU,” can determine the acceleration, orientation, angular rates, and other gravitational forces experienced by the spreader. For instance, the IMU may determine unsafe operating conditions for the spreader as a result of one or more forces exceeding a threshold amount. Exemplary conditions the IMU may detect, or at least detect forces resulting from said conditions, include transportation of the spreader 10 during no operation (e.g., shipping the spreader), excessive speed (e.g., spreader rolling down a steep incline), excessive vibrations (e.g., traversing over rocking terrain), or other conditions not deemed conducive for operation. Thus, in some embodiments, the controller is configured to prevent or cease operation of the motor based on feedback from the IMU or other sensor. While an IMU is disclosed herein, it should also be appreciated that the sensor may simply an accelerometer, a gyroscope, or other suitable sensor.

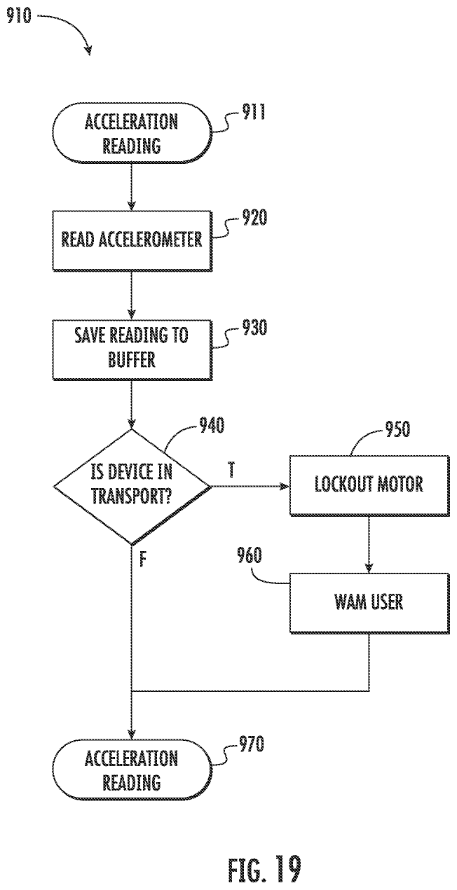

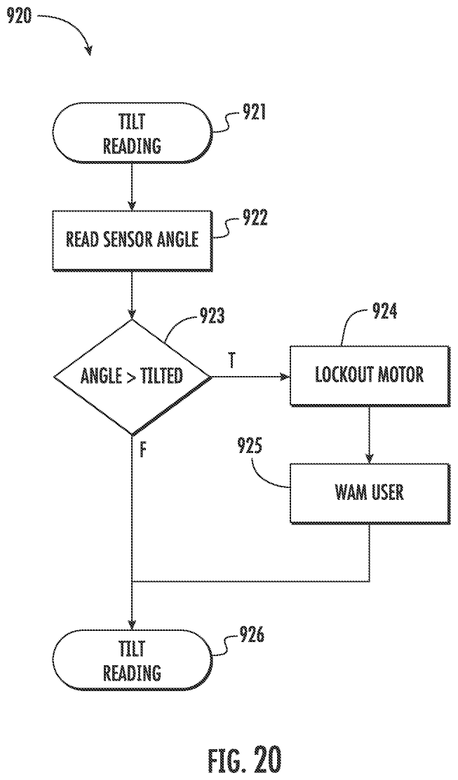

With reference to FIG. 19, an exemplary method 910 is illustrated for using acceleration sensor data, such as from an IMU or an accelerometer. As illustrated, method 910 can first include requesting or sensing an acceleration reading in step 911 followed by reading an accelerometer or other suitable device in step 912. The reading from step 912 can then be optionally stored or otherwise communicated in step 913. The reading is than analyzed in step 914 to determine if the spreader is transport. If it is determined the spreader is in transport in step 914, then the motor can be locked out in step 915 and/or a communication or warning can be sent to a user in step 916. The method 910 can then return to a passive state where it waits for a requested or sensed acceleration reading in step 917. The method 910 can run in loop or can stop upon the transport determination until a user takes an overriding (e.g., all clear) action to reset the spreader. Such methods and variations thereof can prevent undesired operation of the spreader when it is being transported between locations without undergoing normal operation.

A tilt sensor can determine the tilt angle of the spreader from one or more directions. For instance, the tilt sensor may determine unsafe operating conditions for the spreader as a result of the spreader being tilted beyond a predetermined threshold angle. Exemplary conditions the tilt sensor may detect, or at least detect readings indicating said conditions, include the spreader traversing a steep hill, the spreader having fallen over or being knocked down, or other conditions not deemed conducive for operation.

With reference to FIG. 20, an exemplary method 920 is illustrated for using tilt sensor data when the spreader is in a stopped (or non-motion) condition. The method 920 can first include requesting or sensing a tilt reading in step 921 followed by reading a reading a tilt sensor or other suitable device in step 922. The reading from step 922 can then be compared to a predefined or user defined value in step 923 to determine the tilt or other reading exceeds a threshold. If the a tilt threshold is exceeded, the method 920 can include locking out the motor in step 924 and/or communicating with or warning a user in step 925. The method 920 can then return to a passive state where it waits for a requested or sensed tilt reading in step 926. The method 920 can run in loop or can stop upon the excessive tilt determination until a user takes an overriding (e.g., all clear) action to reset the spreader. Such methods and variations thereof can prevent undesired operation.

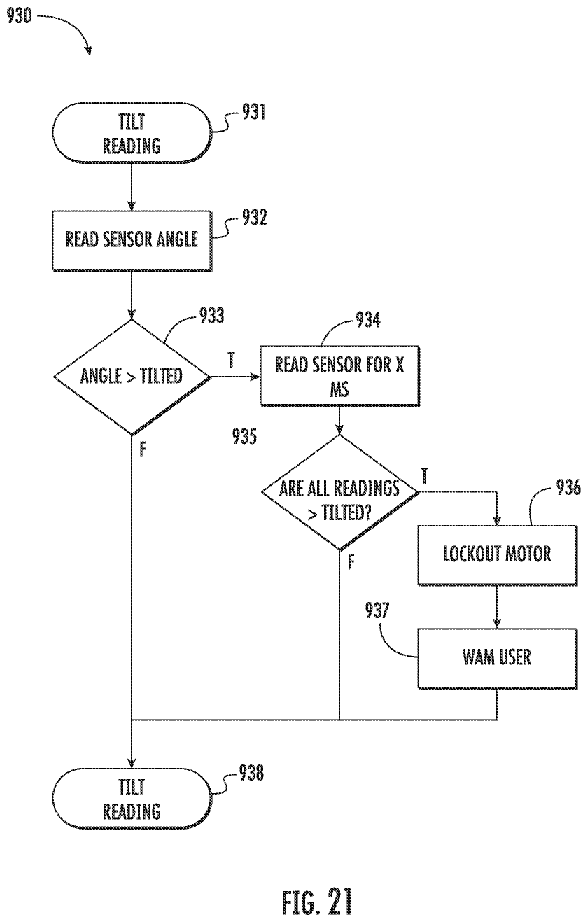

With reference to FIG. 21, an exemplary method 930 is illustrated for using tilt sensor data when the spreader is in a motion (e.g., operation) condition. The method 930 can first include requesting or sensing a tilt reading in step 931 followed by reading a reading a tilt sensor or other suitable device in step 932. The reading from step 932 can then be compared to a predefined or user defined value in step 933 to determine the tilt or other reading exceeds a threshold. If the a tilt threshold is exceeded, the method 930 can include additional sensor readings for an extended period of time, either continuously or periodically, in step 934. After collecting additional readings in step 934, said readings are analyzed in step 935 to determine whether all, some, or none of the additional readings exceed a tilt threshold.

If all, or a threshold number, of the readings exceed the tilt threshold, then the method 930 can include locking out the motor in step 936 and/or communicating with or warning a user in step 937. The method 930 can then return to a passive state where it waits for a requested or sensed tilt reading in step 938. However, if in step 935 it determined that not all, or not a threshold number, of readings exceed the tilt threshold, then method can go directly to step 938 without locking out the motor in step 936 or warning the user in step 937. Such events may occur, for example, when the spreader hits a bump or very temporary uneven terrain that causes a brief jolt to the spreader. The bump may temporarily cause the spreader to be tilted before quickly returning to a normal operating orientation. The method 930 can then run in loop or can stop upon the excessive tilt determination until a user takes an overriding (e.g., all clear) action to reset the spreader. Such methods and variations thereof can prevent undesired operation.

A speed sensor can determine the speed of the spreader or the motor. For instance, the speed sensor may be utilized to determine if a threshold speed is exceeded indicating an undesired operating condition. Thus, the controller may stop or prevent operation of the spreader while the speed reading exceeds the threshold.

In some embodiments, the speed sensor may be used in a closed loop speed control system. That is, feedback from the speed sensor may be used to determine whether the motor should be sped up or slowed down to achieve the targeted speed set by the operator.

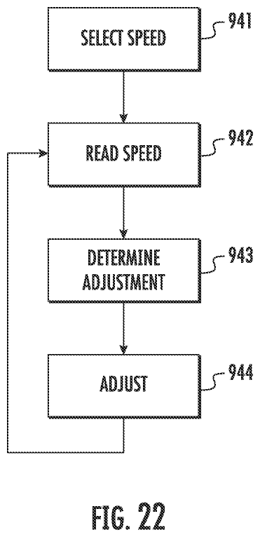

With reference to FIG. 22, an exemplary method 940 is illustrated for operating the spreader using a closed loop speed control system. The method 940 starts with an operator selecting a desired speed in step 941. A speed sensor that determines a speed reading in step 942, either continuously, periodically, intermittently, or in isolation. The speed reading(s) obtained in step 942 is then analyzed in step 943 to determine if the motor needs to be sped up or slowed down to reach the desired speed selected by the operator from step 941. The speed reading may be the speed over the spreader itself, the rotational speed of one or more wheels, or an output value of the motor, which alone or in combination with additional information can be used to determine a desired motor adjustment. Based on the determination in step 943, the motor operation is adjusted in step 944 to adjust the speed towards the desired value. The method 940 can then run in loop repeating steps 942, 943, and 944.

It should be appreciated based on the disclosure herein that, in general, spreaders, such as walk behind spreaders, can be thus used to spread material stored in a hopper across a surface as the spreader is traversed over the ground. The spreaders can incorporate one or more variations to provide greater ease of use to the operator, more selective or precise operation, or otherwise assist in the consistent and safe distribution of material across an area. One or more of the features can be incorporated into the drive assembly of the spreader, into the material storage and distribution of the spreader, and/or into the control operations of the spreader. Further, these features may be used in isolation or in combination with one another.

Further aspects of the invention are provided by one or more of the following embodiments:

A spreader for distributing a material, the spreader comprising a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame; a plurality of wheels operatively connected to the frame for traversing the spreader; and a drive assembly comprising a motor operable to drive one or more of the plurality of wheels, wherein the plurality of wheels can be manually rotated without being driven by the motor, and wherein rotation of the wheels causes the distribution element to rotate.

The spreader of any clause herein, wherein the drive assembly comprises a transmission axle operably connecting the motor to at least a first wheel; and a wheel axle operably connecting the first wheel to the distribution element.

The spreader of any clause herein, further comprising a spinner axle operably connected to the wheel axle via a spinner gear assembly, and wherein the distribution element is fixedly connected to the spinner axle such that rotation of the first wheel causes the distribution element to rotate.

The spreader of any clause herein, wherein the spinner axle is substantially orthogonal with the wheel axle.

The spreader of any clause herein, wherein the wheel axle extends from the first wheel to a second wheel.

The spreader of any clause herein, wherein the wheel axle is fixedly connected to the first wheel and rotatably connected to the second wheel.

The spreader of any clause herein, further comprising a clutch operably disposed between the motor and the first wheel.

The spreader of any clause herein, wherein the clutch comprises a centrifugal clutch that selectively transfers rotational power from the motor to the first wheel when a threshold force is obtained.

The spreader of any clause herein, further comprising a clutch operably connected to the motor, and wherein the transmission axle comprises a first transmission axle extending from the clutch to the first wheel, and a second transmission axle extending from the clutch to a second wheel.

The spreader of any clause herein, wherein the plurality of wheels is two wheels.

The spreader of any clause herein, wherein the motor comprises an electric motor.

The spreader of any clause herein, further comprising a battery receiving compartment configured to selective receive a battery for powering the electric motor.

The spreader of any clause herein, wherein the battery receiving compartment is mounted to the frame.

The spreader of any clause herein, further comprising a controller configured to control one or more operational parameters of the spreader.

The spreader of any clause herein, wherein the one or more operational parameters comprise a power state of the spreader, a speed of the spreader, or a material distribution amount of the spreader.

The spreader of any clause herein, further comprising one or more sensors, wherein the controller controls the one or more operational parameters based on feedback from the one or more sensors.

The spreader of any clause herein, wherein the one or more sensors comprise an inertial motion unit, an accelerometer, a gyroscope, a tilt sensor, or a speed sensor.

A spreader for distributing a material, the spreader comprising a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame; a plurality of wheels operatively connected to the frame for traversing the spreader; a drive assembly comprising a motor operable to drive one or more of the plurality of wheels; and a battery receiving compartment configured to selectively receive a battery for powering the motor, wherein the battery receiving compartment is mounted to the frame.

The spreader of any clause herein, wherein the battery receiving compartment has no direct connection to the hopper assembly.

The spreader of any clause herein, wherein the battery receiving compartment is disposed between the hopper assembly and the handle assembly.

The spreader of any clause herein, wherein the battery receiving compartment comprises a battery lid configured to transition between an open position and a closed position.

The spreader of any clause herein, further comprising a sealing element disposed between the battery lid and the battery receiving compartment.

The spreader of any clause herein, further comprising one or more springs disposed inside the battery receiving compartment, wherein the one or more springs are configured to be compressed when a battery is installed in the battery receiving compartment.

A spreader for distributing a material, the spreader comprising a hopper assembly defining a receiving area configured to hold the material, the hopper assembly comprising one or more dispersion outlets for releasing the material from the receiving area; a distribution element disposed below the one or more dispersion outlets, wherein the distribution element comprises a first elongated surface opposite a second elongated surface, and wherein each of the first elongated surface and the second elongated surface comprise one or more radial contours extending in a radial direction; a frame supporting the hopper assembly; a handle assembly connected to the frame; and a plurality of wheels operatively connected to the frame for traversing the spreader.

The spreader of any clause herein, wherein the first elongated surface comprises a first plurality of radial contours, and wherein the second elongated surface comprises a second plurality of radial contours.

The spreader of any clause herein, wherein the first elongated surface and the first plurality of radial contours have a common configuration as the second elongated surface and the second plurality of radial contours.

The spreader of any clause herein, wherein the first elongated surface and/or the first plurality of radial contours have a different configuration than the second elongated surface and/or the second plurality of radial contours.

The spreader of any clause herein, further comprising a wheel axle extending between a first wheel and a second wheel, wherein rotation of the first wheel causes the wheel axle to rotate.

The spreader of any clause herein, further comprising a spinner axle operably connected to the wheel axle via a spinner gear assembly, and wherein the distribution element is fixedly connected to the spinner axle such that rotation of the first wheel causes the distribution element to rotate.

The spreader of any clause herein, wherein the spinner axle is substantially orthogonal with the wheel axle.

The spreader of any clause herein, wherein the spinner axle passes through a central passage in the distribution element.

The spreader of any clause herein, wherein the central passage and the spinner axle each have a non-circular cross section.

The spreader of any clause herein, wherein the central passage and the spinner axle each have a semi-circular cross section.

A spreader for distributing a material, the spreader comprising a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame; a plurality of wheels operatively connected to the frame for traversing the spreader; and, a lid rotatably coupled to the hopper assembly.

The spreader of any clause herein, wherein the lid comprises a rigid plastic material.

The spreader of any clause herein, wherein the spreader further comprises one or latches for selectively securing the lid in a closed position on the hopper assembly.

The spreader of any clause herein, further comprising a lid sensor configured to detect when the lid is closed.

The spreader of any clause herein, wherein the lid sensor comprises a hall sensor, a pressure sensor, or a photovoltaic sensor.

A spreader for distributing a material, the spreader comprising a hopper assembly defining a receiving area configured to hold the material, the hopper assembly comprising one or more dispersion outlets for releasing the material from the receiving area; a distribution element disposed below the one or more dispersion outlets; a blocking plate that selectively blocks the one or more dispersion outlets; a frame supporting the hopper assembly; a handle assembly connected to the frame; a plurality of wheels operatively connected to the frame for traversing the spreader; and a deflector panel moveable between a stowed position and a deflector position, wherein when the deflector panel is in the deflector position the deflector panel partially blocks material from be spread by the distribution element.

The spreader of any clause herein, further comprising a supplemental regulator configured to selective reduce an opening size of a subset of the one or more dispersion outlets.

The spreader of any clause herein, wherein movement of the deflector panel into the deflector position causes the supplemental regulator to reduce opening size of the subset of the one or more dispersion outlets.

The spreader of any clause herein, wherein the one or more dispersion outlets comprises at least three dispersion outlets, and wherein the subset of the one or more dispersion outlets is a single dispersion outlet.

A spreader for distributing a material, the spreader comprising a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame; a plurality of wheels operatively connected to the frame for traversing the spreader; and a vibrator mounted to the spreader.

The spreader of any clause herein, wherein the vibrator is mounted to the hopper assembly. The spreader of any clause herein, wherein the vibrator is at least partially disposed in the receiving area.

The spreader of any clause herein, wherein the vibrator is mounted to the frame.

The spreader of any clause herein, further comprising a controller configured to control an operation of the vibrator.

The spreader of any clause herein, further comprising one or more sensors, wherein the controller controls the operation of the vibrator based on feedback from the one or more sensors.

A spreader for distributing a material, the spreader comprising a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame; a plurality of wheels operatively connected to the frame for traversing the spreader; a drive assembly comprising a motor operable to drive one or more of the plurality of wheels; one or more sensors configured to determine one or more operational conditions of the spreader; and a controller configured to control one or more operational parameters of the spreader based on feedback from the one or more sensors.

The spreader of any clause herein, wherein the one or more operational parameters comprise a power state of the spreader, a speed of the spreader, or a material distribution amount of the spreader.

The spreader of any clause herein, wherein the one or more sensors comprise an inertial motion unit, an accelerometer, a gyroscope, a tilt sensor, a speed sensor, a hall sensor, a pressure sensor, or a photovoltaic sensor.

The spreader of any clause herein, wherein the one or more operational conditions comprises a movement of the spreader.

The spreader of any clause herein, wherein the controller is configured to lockout the motor if the movement exceeds a threshold.

The spreader of any clause herein, wherein the controller is configured to notify an operator if the movement exceeds a threshold.

The spreader of any clause herein, wherein the one or more operational conditions comprises a tilt angle.

The spreader of any clause herein, wherein the controller is configured to lockout the motor if the tilt angle exceeds a threshold.

The spreader of any clause herein, wherein the controller is configured to notify an operator if the tilt angle exceeds a threshold.

The spreader of any clause herein, wherein the controller is configured to obtain additional tilt angle measurements if a first tilt angle measurement exceeds a threshold.

The spreader of any clause herein, wherein the controller is configured to lockout the motor or notify an operator if the additional tilt angle measurements also exceed the threshold.

A spreader for distributing a material, the spreader comprising a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame; a plurality of wheels operatively connected to the frame for traversing the spreader; a drive assembly comprising a motor operable to drive one or more of the plurality of wheels; one or more sensors configured to determine one or more operational conditions of the spreader; and a controller configured to control an operation of the motor of the spreader based on feedback from the one or more sensors.

The spreader of any clause herein, wherein the controller compares feedback from the one or more sensors to a desired speed selected by an operator and subsequently adjusts the operation of the motor.

The spreader of any clause herein, wherein the one or more sensors comprise a speed sensor.

A spreader for distributing a material, the spreader comprising a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame comprising a bail bar; a plurality of wheels operatively connected to the frame for traversing the spreader; and a drive assembly comprising a motor operable to drive one or more of the plurality of wheels, wherein the motor only drives the one or more of the plurality of wheels when the bail bar is actuated into an engaged position.

The spreader of any clause herein, further comprising an arming button, wherein the motor only drives the one or more of the plurality of wheels when the bail bar is actuated into an engaged position and the arming button is in an armed condition.

The spreader of any clause herein, further comprising a speed selection interface, wherein the motor only drives the one or more of the plurality of wheels when the bail bar is actuated into an engaged position and a desired speed is selected via the speed selection interface.

The spreader of any clause herein, further comprising one or more drive paddles, wherein the motor only drives the one or more of the plurality of wheels when the bail bar is actuated into an engaged position and at least one of the one or more drive paddles is actuated.

The spreader of any clause herein, wherein the one or more drive paddles comprises two drive paddles, and wherein the motor only drives the one or more of the plurality of wheels when the bail bar is actuated into an engaged position and at least one of two drive paddles is actuated.

The spreader of any clause herein, wherein the bail bar moves in a first direction to reach the engaged position, wherein the one or more drive paddles move in a second direction when actuated, and wherein the first direction is different than the second direction.

A spreader for distributing a material, the spreader comprising a hopper assembly defining a receiving area configured to hold the material, the hopper assembly comprising one or more dispersion outlets for releasing the material from the receiving area; a distribution element disposed below the one or more dispersion outlets; a frame supporting the hopper assembly; a handle assembly connected to the frame, the handle assembly comprising a user interface configured to display one or more operational parameters of the spreader; a plurality of wheels operatively connected to the frame for traversing the spreader; and a drive assembly comprising a motor operable to drive one or more of the plurality of wheels.

The spreader of any clause herein, wherein the one or more operational parameters comprise a power state of the spreader, a speed of the spreader, or a material distribution amount of the spreader, an amount of material in the receiving area, or a battery gauge.

The spreader of any clause herein, wherein the user interface is further configured to receiving user input for controlling one or more operational parameters.

The spreader of any clause herein, wherein the user interface comprises a speed selection.

The spreader of any clause herein, wherein the speed selection comprises a plurality of preset speeds.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A spreader for distributing a material, the spreader comprising:
a hopper assembly defining a receiving area configured to hold the material, the hopper assembly comprising one or more dispersion outlets for releasing the material from the receiving area;
a distribution element disposed below the one or more dispersion outlets;
a frame supporting the hopper assembly;
a handle assembly connected to the frame;
a plurality of wheels operatively connected to the frame for traversing the spreader; and
a drive assembly comprising a motor operable to drive one or more of the plurality of wheels, wherein the plurality of wheels can be manually rotated without being driven by the motor, and wherein rotation of the wheels causes the distribution element to rotate.

2. The spreader of claim 1, wherein the drive assembly comprises:
a transmission axle operably connecting the motor to at least a first wheel; and
a wheel axle operably connecting the first wheel to the distribution element.

3. The spreader of claim 2, further comprising a spinner axle operably connected to the wheel axle via a spinner gear assembly, and wherein the distribution element is fixedly connected to the spinner axle such that rotation of the first wheel causes the distribution element to rotate.

4. The spreader of claim 3, wherein the spinner axle is substantially orthogonal with the wheel axle.

5. The spreader of claim 2, wherein the wheel axle extends from the first wheel to a second wheel.

6. The spreader of claim 5, wherein the wheel axle is fixedly connected to the first wheel and rotatably connected to the second wheel.

7. The spreader of claim 2, further comprising a clutch operably disposed between the motor and the first wheel.

8. The spreader of claim 7, wherein the clutch comprises a centrifugal clutch that selectively transfers rotational power from the motor to the first wheel when a threshold force is obtained.

9. The spreader of claim 2, further comprising a clutch operably connected to the motor, and wherein the transmission axle comprises a first transmission axle extending from the clutch to the first wheel, and a second transmission axle extending from the clutch to a second wheel.

10. The spreader of claim 4, wherein the motor comprises an electric motor.

11. The spreader of claim 10, further comprising a battery receiving compartment configured to selectively receive a battery for powering the electric motor.

12. The spreader of claim 1, further comprising a controller configured to control one or more operational parameters of the spreader.

13. The spreader of claim 12, wherein the one or more operational parameters comprise a power state of the spreader, a speed of the spreader, or a material distribution amount of the spreader.

14. The spreader of claim 12, further comprising one or more sensors, wherein the controller controls the one or more operational parameters based on feedback from the one or more sensors.

15. The spreader of claim 14, wherein the one or more sensors comprise an inertial motion unit, an accelerometer, a gyroscope, a tilt sensor, or a speed sensor.

16. A spreader for distributing a material, the spreader comprising:
a hopper assembly defining a receiving area configured to hold the material, the hopper assembly comprising one or more dispersion outlets for releasing the material from the receiving area;
a distribution element disposed below the one or more dispersion outlets;
a frame supporting the hopper assembly;
a handle assembly connected to the frame;
a plurality of wheels operatively connected to the frame for traversing the spreader;
a drive assembly comprising:
a motor operable to drive one or more of the plurality of wheels; and
a battery receiving compartment configured to selectively receive a battery for powering the motor, wherein the battery receiving compartment is mounted to the frame.

17. The spreader of claim 16, wherein the battery receiving compartment has no direct connection to the hopper assembly.

18. The spreader of claim 16, wherein the battery receiving compartment is disposed between the hopper assembly and the handle assembly.

19. The spreader of claim 16, wherein the battery receiving compartment comprises a battery lid configured to transition between an open position and a closed position.

20. The spreader of claim 19, further comprising a sealing element disposed between the battery lid and the battery receiving compartment.

21. The spreader of claim 19, further comprising one or more springs disposed inside the battery receiving compartment, wherein the one or more springs are configured to be compressed when a battery is installed in the battery receiving compartment.
